(19) United States
(12) Patent Application Publication
(10) Pub. No.: US 2023/0202380 A1
(43) Pub. Date: Jun. 29, 2023

(54) VEHICLE LIGHTING CONTROL DEVICE

(71) Applicant: Toyota Jidosha Kabushiki Kaisha, Toyota-shi Aichi-ken (JP)

(72) Inventor: Tetsuya IKUTA, Nisshin-shi Aichi (JP)

(73) Assignee: Toyota Jidosha Kabushiki Kaisha, Toyota-shi Aichi-ken (JP)

(21) Appl. No.: 18/084,982

(22) Filed: Dec. 20, 2022

(30) Foreign Application Priority Data
Dec. 27, 2021 (JP) 2021-212035

(51) Int. Cl. B60Q 1/08; B60Q 1/14

(52) U.S. Cl. CPC B60Q 1/08; B60Q 1/143; B60Q 2300/337; B60Q 2300/05

(57) ABSTRACT

A vehicle lighting control device includes: a control determination unit that determines whether or not a state of a vehicle is a control target state in which an arrival time required for the vehicle to arrive at a tunnel is less than a predetermined reference arrival time; and a lighting controller that executes a first control to control a headlight to a low beam when a forward vehicle is detected and to control the headlight to a high beam when the forward vehicle is not detected. The lighting controller is configured to prevent the headlight from being switched to the high beam in the first control when determination is made that the vehicle is in the control target state even when a state in which the forward vehicle is detected is changed to a state in which the forward vehicle is not detected.

### CROSS-REFERENCE TO RELATED APPLICATION

This application claims the benefit of priority from Japanese Patent Application No. 2021-212035, filed on Dec. 27, 2021, the entire contents of which are incorporated herein by reference.

### TECHNICAL FIELD

The present disclosure relates to a vehicle lighting control device that controls a headlight of a vehicle.

### BACKGROUND

There are various devices that perform control to turn on headlights of a vehicle. For example, Japanese Unexamined Patent Publication No. 2001-39210 discloses a device that turns on a headlight when a vehicle enters a tunnel. In addition, as another example, there is a device that controls a headlight of a vehicle to a low beam when a forward vehicle is detected, and that controls the headlight to a high beam when the forward vehicle is not detected.

### SUMMARY

For example, it is conceivable to combine the above-mentioned function of controlling the headlight depending on the presence or absence of the forward vehicle and the above-mentioned function of turning on the headlight based on the entry into the tunnel. At that time, since tunnel lights are installed in the tunnel so that it is bright enough to recognize the surroundings, the headlight is controlled to the low beam instead of the high beam in the tunnel.

In this configuration, the forward vehicle may not be detected in front of the entrance of the tunnel due to a curve of the road or the like while the headlight is turned on with low beam after the forward vehicle is detected in front of the tunnel. In this case, the headlight is switched from the low beam to the high beam. However, since the vehicle enters the tunnel, the headlight is switched from the low beam to the high beam as soon as the vehicle enters the tunnel. For this reason, the vehicle may appear to flash high beams (to momentarily turn on high beams) toward a person around the vehicle (for example, an occupant of an oncoming vehicle), which may make the person around the vehicle feel irritable.

Therefore, in the present disclosure, a vehicle lighting control device capable of appropriately controlling a headlight will be described.

One aspect of the present disclosure relates to a vehicle lighting control device that performs control to switch between a low beam and a high beam of a headlight of a vehicle, the vehicle lighting control device including: a forward vehicle detection unit configured to detect a forward vehicle in front of the vehicle; a tunnel recognition unit configured to recognize a tunnel in front of the vehicle; a control determination unit configured to determine whether or not a state of the vehicle is a control target state in which an arrival time required for the vehicle to arrive at the recognized tunnel is less than a predetermined reference arrival time; and a lighting controller configured to execute a first control to control the headlight to the low beam when the forward vehicle is detected and to control the headlight to the high beam when the forward vehicle is not detected, while the vehicle is traveling outside the tunnel, and a second control to control the headlight to the low beam when the vehicle enters the tunnel, in which the lighting controller is configured to prevent the headlight from being switched to the high beam in the first control when determination is made that the vehicle is in the control target state even when a state in which the forward vehicle is detected is changed to a state in which the forward vehicle is not detected.

In this vehicle lighting control device, when the arrival time to the tunnel is less than the reference arrival time even when the forward vehicle is no longer detected, the switch from the low beam to the high beam of the headlight is not performed in the first control and the state of the low beam is maintained. Then, the vehicle lighting control device can allow the vehicle to enter the tunnel in the state of the low beam, and can make the vehicle into the state of the low beam through the second control in the tunnel That is, the switch to the high beam that is performed when the forward vehicle is no longer detected in front of the entrance of the tunnel, and the switch to the low beam that is performed when the vehicle enters the tunnel are not performed. This prevents a person around the vehicle from experiencing the vehicle's high beam flashing in front of the entrance of the tunnel. In this way, the vehicle lighting control device can appropriately control the headlight.

Another aspect of the present disclosure relates to a vehicle lighting control device that performs control to switch between a low beam and a high beam of a headlight of a vehicle, the vehicle lighting control device including: a forward vehicle detection unit configured to detect a forward vehicle in front of the vehicle; a tunnel recognition unit configured to recognize a tunnel in front of the vehicle; a control determination unit configured to determine whether or not a state of the vehicle is a control target state in which the vehicle is located within a control prevention area from a determination location set in advance in front of the recognized tunnel to an entrance of the tunnel; and a lighting controller configured to execute a first control to control the headlight to the low beam when the forward vehicle is detected and to control the headlight to the high beam when the forward vehicle is not detected, while the vehicle is traveling outside the tunnel, and a second control to control the headlight to the low beam when the vehicle enters the tunnel, in which the lighting controller is configured to prevent the headlight from being switched to the high beam in the first control when determination is made that the vehicle is in the control target state even when a state in which the forward vehicle is detected is changed to a state in which the forward vehicle is not detected.

In this vehicle lighting control device, when the vehicle travels at a position closer to the entrance of the tunnel than to the determination location even when the forward vehicle is no longer detected, the switch from the low beam to the high beam of the headlight is not performed in the first control and the state of the low beam is maintained. Then, the vehicle lighting control device can allow the vehicle to enter the tunnel in the state of the low beam, and can make the vehicle into the state of the low beam through the second control in the tunnel. That is, the switch to the high beam that is performed when the forward vehicle is no longer detected in front of the entrance of the tunnel, and the switch to the low beam that is performed when the vehicle enters the tunnel are not performed. This prevents a person around the vehicle from experiencing the vehicle's high beam flashing in front of the entrance of the tunnel. In this way, the vehicle lighting control device can appropriately control the headlight.

In the vehicle lighting control device, the lighting controller may be configured to cancel the prevention of the switch to the high beam in the first control, in at least one of a case where a predetermined time has elapsed after the headlight is prevented from being switched to the high beam in the first control, a case where the vehicle travels a predetermined distance after the headlight is prevented from being switched to the high beam in the first control, and a case where the vehicle enters the tunnel and the second control is started. In this case, the vehicle lighting control device can cancel the prevention of the switch to the high beam in the first control, at appropriate timing.

According to various aspects of the present disclosure, the headlight can be appropriately controlled.

### BRIEF DESCRIPTION OF THE DRAWINGS

FIG. 1 is a block diagram showing an overall configuration of a vehicle lighting control device according to an embodiment.

FIG. 2 is a diagram illustrating a status of each unit and the like when a headlight is prevented from being switched to a high beam in a first control.

FIG. 3 is a flowchart showing a flow of processing of preventing the headlight from being switched to the high beam in the first control.

### DETAILED DESCRIPTION

Hereinafter, exemplary embodiments will be described with reference to the drawings. In each figure, the same or corresponding elements are designated by the same reference numerals, and duplicate descriptions will not be repeated.

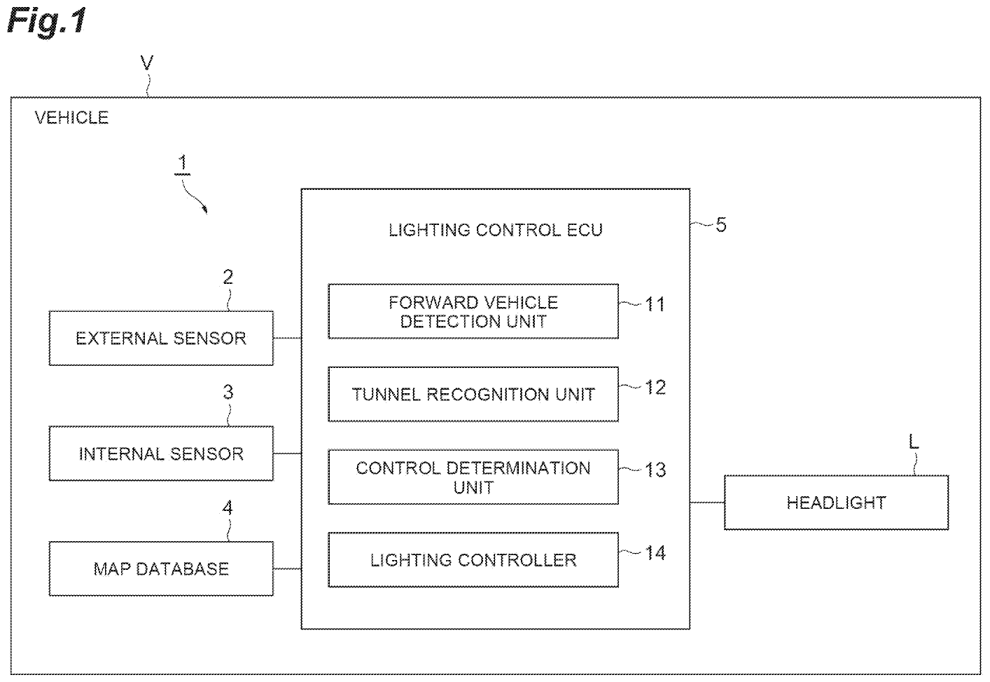

A vehicle lighting control device 1 shown in FIG. 1 is mounted on a vehicle V and performs control to switch between a high beam and a low beam of a headlight L of the vehicle V. A part of the vehicle lighting control device 1 may be provided outside the vehicle V. The vehicle V may be an autonomous driving vehicle that autonomously travels, or may be a manual driving vehicle in which a driving operation is performed by a driver. The headlight L is a light that irradiates an area in front of the vehicle V. The headlights L are provided, for example, at positions on the left side and the right side of the front end of the vehicle V, respectively. Hereinafter, as the control of the headlight L performed by the vehicle lighting control device 1, the control to switch between the high beam and the low beam of the headlight L will be mainly described.

The vehicle lighting control device 1 includes an external sensor 2, an internal sensor 3, a map database 4, and a lighting control electronic control unit [ECU] 5.

The external sensor 2 is a detection device that detects the external environment of the vehicle V. The external sensor 2 includes at least one of a camera and a radar sensor.

The camera is an imaging device that captures images of the external environment of the vehicle V. The camera is provided behind the windshield of the vehicle V and captures images of the area in front of the vehicle. The camera transmits imaging information regarding the external environment of the vehicle V to the lighting control ECU 5. The camera may be a monocular camera or a stereo camera.

A radar sensor is a detection device that uses radio waves (for example, millimeter waves) or light to detect an object in the area around the vehicle V, including at least the area in front of the vehicle V. The radar sensor includes, for example, a millimeter wave radar or a light detection and ranging [LIDAR]. The radar sensor transmits radio waves or light to the area around the vehicle V and receives radio waves or light reflected by an object to detect the object. The radar sensor transmits the detected object information to the lighting control ECU 5.

The internal sensor 3 is an in-vehicle sensor that detects the state of the vehicle V. The internal sensor 3 includes, for example, a Global Positioning System [GPS] sensor, an inertial measurement unit [IMU], and a vehicle speed sensor. The GPS sensor receives signals from three or more GPS satellites to measure the position of the vehicle V (for example, the latitude and longitude of the vehicle V). The GPS sensor transmits the measured position information of the vehicle V to the lighting control ECU 5.

The vehicle speed sensor is a detector that detects the speed of the vehicle V. As the vehicle speed sensor, a wheel speed sensor that is provided for a wheel of the vehicle V, a drive shaft which rotates integrally with the wheel, or the like and that detects the rotation speed of each wheel can be used. The vehicle speed sensor transmits the detected vehicle speed information (wheel speed information) to the lighting control ECU 5.

The map database 4 is a database in which map information is recorded. The map database 4 is formed in, for example, a recording device, such as an HDD mounted on the vehicle V. The map information includes road position information, road shape information (for example, curvature information), tunnel information, and the like. The tunnel information includes at least the position information of the entrance and exit of the tunnel. The map database 4 may be formed as a server capable of communicating with the vehicle V.

The lighting control ECU 5 is an electronic control unit having a central processing unit [CPU], a read only memory [ROM], a random access memory [RAM], and the like. In the lighting control ECU 5, for example, a program recorded in the ROM or the RANI is executed by the CPU so that various functions are realized. The lighting control ECU 5 may be composed of a plurality of electronic units.

The lighting control ECU 5 functionally includes a forward vehicle detection unit 11, a tunnel recognition unit 12, a control determination unit 13, and a lighting controller 14.

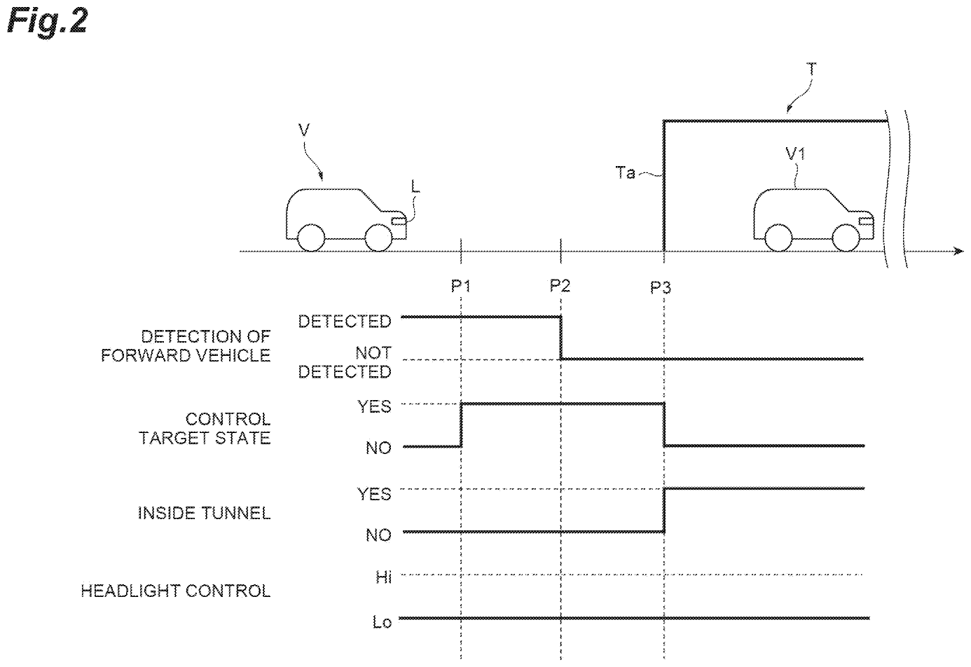

The forward vehicle detection unit 11 detects a forward vehicle V1 (see FIG. 2) in front of the vehicle V. Here, the forward vehicle V1 includes a preceding vehicle traveling in front of the vehicle V and an oncoming vehicle traveling toward the vehicle V. The forward vehicle detection unit 11 can detect the forward vehicle V1 through various methods. For example, the forward vehicle detection unit 11 may be configured to detect the forward vehicle V1 by recognizing the forward vehicle V1 through a well-known method, based on the captured image captured by the camera of the external sensor 2. Alternatively, the forward vehicle detection unit 11 may be configured to detect the forward vehicle V1 by recognizing the forward vehicle V1 through a well-known method, based on the detection result of the radar sensor of the external sensor 2.

The tunnel recognition unit 12 recognizes a tunnel T (see FIG. 2) in front of the vehicle V and calculates the distance to the tunnel T. The tunnel recognition unit 12 can recognize the tunnel T in front of the vehicle V and calculate the distance to the entrance of the tunnel T, through various methods. For example, the tunnel recognition unit 12 may recognize the tunnel T and calculate the distance to the entrance of the tunnel T through a well-known method, based on the captured image captured by the camera of the external sensor 2. Alternatively, for example, the tunnel recognition unit 12 may recognize the tunnel T and calculate the distance to the entrance of the tunnel T, based on the position information of the vehicle V measured by the GPS sensor of the internal sensor 3 and the tunnel information stored in the map database 4. The tunnel recognition unit 12 can calculate the distance to the entrance of the tunnel T in consideration of the shape (curve and the like) of the road in front of the vehicle V. Further, the tunnel recognition unit 12 recognizes a tunnel T existing within a predetermined distance in front of the vehicle V, as the tunnel T in front of the vehicle V.

Furthermore, the tunnel recognition unit 12 recognizes whether or not the vehicle V has entered the tunnel T. That is, the tunnel recognition unit 12 recognizes whether or not the vehicle V is traveling in the tunnel T. The tunnel recognition unit 12 can recognize the presence or absence of entry into the tunnel through the same method as the above-mentioned recognition of the tunnel T.

The control determination unit 13 determines whether or not the state of the vehicle V is a control target state. In the present embodiment, the control target state is a state in which the arrival time (the time it takes for the vehicle V to arrive at the tunnel T) required for the vehicle V to arrive at the tunnel T recognized by the tunnel recognition unit 12 is less than a predetermined reference arrival time. Here, the control determination unit 13 can calculate the arrival time required for the vehicle V to arrive at the tunnel T based on, for example, the distance to the tunnel T calculated by the tunnel recognition unit 12 and the speed of the vehicle V. Further, the control determination unit 13 can use, for example, the detection result of the vehicle speed sensor of the internal sensor 3 as the speed of the vehicle V. The control determination unit 13 determines whether or not the vehicle V is in the control target state by comparing the calculated arrival time with the reference arrival time.

The lighting controller 14 performs control to switch between the high beam and the low beam of the headlight L by instructing the headlight L. Further, the lighting controller 14 executes a first control and a second control, as the control to switch between the high beam and the low beam.

The first control is a control executed while the vehicle V is traveling outside the tunnel T. As the first control, the lighting controller 14 controls the headlight L to the low beam when the forward vehicle V1 is detected by the forward vehicle detection unit 11, and controls the headlight L to the high beam when the forward vehicle V1 is not detected, while the vehicle V is traveling outside the tunnel T.

The second control is a control executed when the vehicle V enters the tunnel T (when the vehicle V is traveling in the tunnel T). As the second control, the lighting controller 14 controls the headlight L to the low beam when the vehicle V enters the tunnel T.

Further, when the vehicle V approaches the tunnel T, the lighting controller 14 prevents the headlight L from being switched from the low beam to the high beam in the first control, in a predetermined case. Preventing the headlight L from being switched from the low beam to the high beam here means maintaining the state of the low beam without switching the headlight L from the low beam to the high beam.

Specifically, the lighting controller 14 prevents the headlight from being switched to the high beam in the first control when determination is made that the vehicle V is in the control target state even when a state in which the forward vehicle V1 is detected is changed to a state in which the forward vehicle V1 is not detected.

Further, the lighting controller 14 cancels the prevention of the switch to the high beam in the first control, in a predetermined case. Here, the lighting controller 14 may cancel the prevention of the switch to the high beam in the first control when a predetermined time has elapsed after the prevention. Alternatively, the lighting controller 14 may cancel the prevention of the switch to the high beam in the first control when the vehicle V travels a predetermined distance after the prevention. Alternatively, the lighting controller 14 may cancel the prevention of the switch to the high beam in the first control when the vehicle V enters the tunnel T and the second control is started. That is, before the lighting controller 14 should cancel the prevention of the switch to the high beam after once preventing the headlight L from being switched to the high beam in the first control, the lighting controller 14 prevents the headlight L from being switched to the high beam regardless of the detection state of the forward vehicle V1.

Here, the status of each unit and the like when the headlight is prevented from being switched to the high beam in the first control will be described with reference to FIG. 2. In the example shown in FIG. 2, the vehicle V is traveling toward an entrance Ta of the tunnel T. In addition, the forward vehicle detection unit 11 of the vehicle lighting control device 1 is assumed to be in a state in which the forward vehicle V1 is detected in front of the vehicle V (detection of the forward vehicle: detected). Therefore, the lighting controller 14 controls the headlight L to the low beam (Lo) as the first control.

It is assumed that the vehicle V travels toward the tunnel T and the arrival time to the tunnel T (entrance Ta) is less than the reference arrival time at location P1. That is, at location P1, the control determination unit 13 determines that the state of the vehicle V is the control target state (control target state: YES). Further, it is assumed that the vehicle V travels and the forward vehicle detection unit 11 cannot detect the forward vehicle V1 at location P2 (detection of the forward vehicle: not detected). For example, it is considered that the forward vehicle V1 is no longer detected by the forward vehicle detection unit 11 due to the influence of the curve of the road or the like.

In this case, the lighting controller 14 prevents the headlight L from being switched to the high beam in the first control after location P2 because the vehicle V is in the control target state even when the forward vehicle V1 is no longer detected. Further, when the vehicle V travels and arrives at location P3 of the entrance Ta of the tunnel T, the control determination unit 13 determines that the vehicle V is not in the control target state (control target state: NO). Then, the tunnel recognition unit 12 recognizes that the vehicle V has entered the tunnel T (inside the tunnel: YES). With this, the lighting controller 14 controls the headlight L to the low beam as the second control after location P3 at which the vehicle V has entered the tunnel T. Here, the headlight L is in the state of the low beam when the vehicle V arrives at location P3 because, at location P2, the vehicle V is in the control target state even when the forward vehicle V1 is no longer detected. Therefore, the lighting controller 14 continues to maintain the state of the low beam at location P3.

As described above, when determination is made that the vehicle V is in the control target state in front of the tunnel T (between location P1 and location P3), the lighting controller 14 prevents the headlight L from being switched to the high beam even when the forward vehicle V1 is no longer detected at location P2. After that, the lighting controller 14 cancels the prevention of the switch to the high beam in the first control, in a predetermined case, as described above.

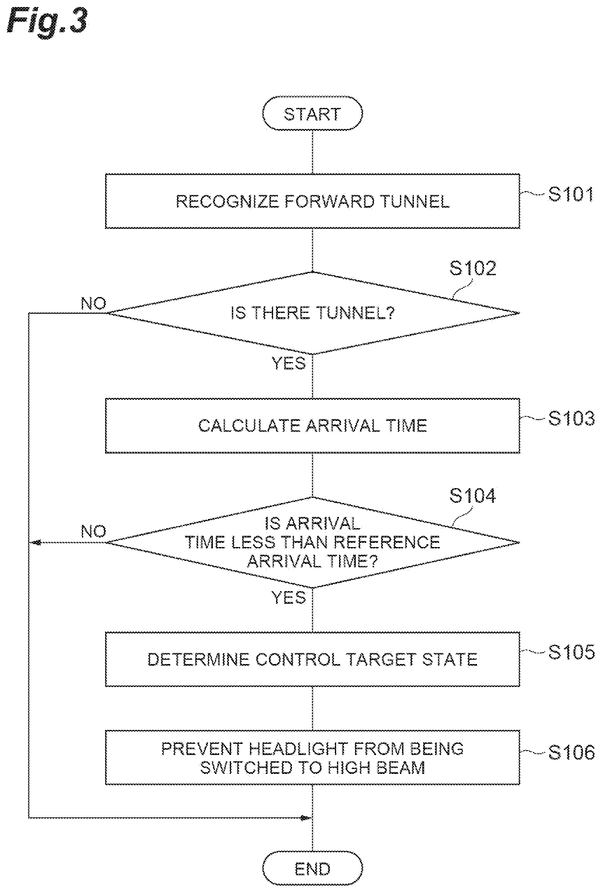

Next, the flow of processing of preventing the headlight L from being switched to the high beam in the first control, which is performed in the vehicle lighting control device 1, will be described with reference to the flowchart of FIG. 3. In the processing shown in FIG. 3, when the processing reaches the end, the processing is started from the start after a predetermined time. As shown in FIG. 3, the tunnel recognition unit 12 performs processing of recognizing the tunnel T in front of the vehicle V (S101). When the tunnel is not recognized (S102: NO), the process proceeds to the end.

When the tunnel T is recognized (S102: YES), the tunnel recognition unit 12 calculates the distance to the entrance Ta of the tunnel T. Then, the control determination unit 13 calculates the arrival time required for the vehicle V to arrive at the tunnel T (entrance Ta) (S103). The control determination unit 13 determines whether or not the calculated arrival time is less than the reference arrival time (S104). When the arrival time is not less than the reference arrival time (S104: NO), the process proceeds to the end.

When the arrival time is less than the reference arrival time (S104: YES), the lighting controller 14 determines that the vehicle V is in the control target state (S105). Then, the lighting controller 14 prevents the headlight L from being switched from the low beam to the high beam in the first control (S106). With this, the state of the low beam is maintained even when the forward vehicle V1 is no longer detected.

As described above, in this vehicle lighting control device 1, when the arrival time to the tunnel T is less than the reference arrival time even when the forward vehicle V1 is no longer detected, the headlight L is not switched from the low beam to the high beam in the first control and the state of the low beam is maintained. Then, the vehicle lighting control device 1 can allow the vehicle V to enter the tunnel T in the state of the low beam, and can make the vehicle V into the state of the low beam through the second control in the tunnel T. That is, the switch to the high beam that is performed when the forward vehicle V1 is no longer detected in front of the entrance Ta of the tunnel T, and the switch to the low beam that is performed when the vehicle V enters the tunnel T are not performed. This prevents a person around the vehicle from experiencing the vehicle's high beam flashing in front of the entrance of the tunnel T. In this way, the vehicle lighting control device 1 can appropriately control the headlight L.

The lighting controller 14 cancels the prevention of the switch to the high beam in the first control, in at least one of a case where a predetermined time has elapsed after the headlight is prevented from being switched to the high beam in the first control, a case where the vehicle V travels a predetermined distance after the headlight is prevented from being switched to the high beam in the first control, and a case where the vehicle V enters the tunnel T and the second control is started. In this case, the vehicle lighting control device 1 can cancel the prevention of the switch to the high beam in the first control, at appropriate timing.

Although the embodiment of the present disclosure has been described above, the present disclosure is not limited to the above embodiment. For example, the control determination unit 13 is not limited to determining whether or not the vehicle V is in the control target state by using the arrival time to the tunnel T. For example, the control determination unit 13 can also determine whether or not the vehicle V is in the control target state, based on the position of the vehicle V. Specifically, the control determination unit 13 determines that the vehicle V is in the control target state when the vehicle V is located within a control prevention area set in front of the tunnel T. The control prevention area is an area from a determination location set in advance in front of the tunnel T recognized by the tunnel recognition unit 12 to the entrance Ta of the tunnel T. In this way, the control determination unit 13 can also determine whether or not the state of the vehicle V is the control target state in which the vehicle is located within the control prevention area. Even in this case, the vehicle lighting control device 1 can appropriately control the headlight L as in the above-mentioned embodiment.

In addition to the switch between the high beam and the low beam of the headlight L, the vehicle lighting control device 1 can also prevent the switch of a light distribution control of an adaptive high beam system (AHS) that controls the light distribution of the headlight. Further, the vehicle lighting control device 1 can also prevent a lamp other than the headlight L from being switched.

The vehicle lighting control device 1 may also prevent the headlight L from being switched to the high beam when the vehicle V enters a specific area, in addition to the entry into the tunnel T. This specific area may be, for example, a bright urban area because of the installation of street lights. In this case, the vehicle lighting control device 1 prevents the headlight L from being switched to the high beam even when the forward vehicle V1 is no longer detected when the vehicle V enters the urban area, so that it is possible to prevent the high beam from being momentarily turned on when the vehicle V enters the urban area.

Further, the vehicle lighting control device 1 also prevents the headlight L from being switched to the high beam, for example, when the operation vehicle speed is a predetermined operation vehicle speed or higher immediately before the vehicle V enters a bright area, in addition to the case where the forward vehicle V1 is no longer detected, so that it is possible to prevent the high beam from being momentarily turned on.

At least a part of the above-described embodiments and various modification examples may be arbitrarily combined.

What is claimed is:

1. A vehicle lighting control device that performs control to switch between a low beam and a high beam of a headlight of a vehicle, the vehicle lighting control device comprising:
a forward vehicle detection unit configured to detect a forward vehicle in front of the vehicle;
a tunnel recognition unit configured to recognize a tunnel in front of the vehicle;
a control determination unit configured to determine whether or not a state of the vehicle is a control target state in which an arrival time required for the vehicle to arrive at the recognized tunnel is less than a predetermined reference arrival time; and
a lighting controller configured to execute a first control to control the headlight to the low beam when the forward vehicle is detected and to control the headlight to the high beam when the forward vehicle is not detected, while the vehicle is traveling outside the tunnel, and a second control to control the headlight to the low beam when the vehicle enters the tunnel,
wherein the lighting controller is configured to prevent the headlight from being switched to the high beam in the first control when determination is made that the vehicle is in the control target state even when a state in which the forward vehicle is detected is changed to a state in which the forward vehicle is not detected.

2. A vehicle lighting control device that performs control to switch between a low beam and a high beam of a headlight of a vehicle, the vehicle lighting control device comprising:
a forward vehicle detection unit configured to detect a forward vehicle in front of the vehicle;
a tunnel recognition unit configured to recognize a tunnel in front of the vehicle;
a control determination unit configured to determine whether or not a state of the vehicle is a control target state in which the vehicle is located within a control prevention area from a determination location set in advance in front of the recognized tunnel to an entrance of the tunnel; and
a lighting controller configured to execute a first control to control the headlight to the low beam when the forward vehicle is detected and to control the headlight to the high beam when the forward vehicle is not detected, while the vehicle is traveling outside the tunnel, and a second control to control the headlight to the low beam when the vehicle enters the tunnel,
wherein the lighting controller is configured to prevent the headlight from being switched to the high beam in the first control when determination is made that the vehicle is in the control target state even when a state in which the forward vehicle is detected is changed to a state in which the forward vehicle is not detected.

3. The vehicle lighting control device according to claim 1,
wherein the lighting controller is configured to cancel the prevention of the switch to the high beam in the first control, in at least one of a case where a predetermined time has elapsed after the headlight is prevented from being switched to the high beam in the first control, a case where the vehicle travels a predetermined distance after the headlight is prevented from being switched to the high beam in the first control, and a case where the vehicle enters the tunnel and the second control is started.

4. The vehicle lighting control device according to claim 2,
wherein the lighting controller is configured to cancel the prevention of the switch to the high beam in the first control, in at least one of a case where a predetermined time has elapsed after the headlight is prevented from being switched to the high beam in the first control, a case where the vehicle travels a predetermined distance after the headlight is prevented from being switched to the high beam in the first control, and a case where the vehicle enters the tunnel and the second control is started.
